(19) United States
(12) Patent Application Publication
(10) Pub. No.: US 2019/0346075 A1
(43) Pub. Date: Nov. 14, 2019

(54) ADAPTER WITH TWO MALE THREADS

(71) Applicant: ZhongShan QingYi Metal Products Enterprise CO., LTD., ZhongShan City (CN)

(72) Inventor: Tang Chieh YU, Taichung City (TW)

(21) Appl. No.: 15/976,218

(22) Filed: May 10, 2018

(51) Int. Cl. F16L 15/08; F16L 55/00

(52) U.S. Cl. CPC F16L 15/08; F16L 55/00

(57) ABSTRACT

An adapter with two male threads includes an integrally-connected body and a hanger. The two ends of the body are penetrated by a through hole and each have an external thread segment. The body has two spaced-apart flanges between the two external thread segments. A groove is formed between the two flanges. One end of the hanger has a first connecting portion connectedly disposed in the groove. The other end of the hanger has a second connecting portion connected to an external object. Therefore, two water pipes each having a female thread connection end can be connected by the two external thread segments of the body to ensure ease of use and cut manufacturing costs.

### BACKGROUND OF THE INVENTION

### 1. Technical Field

The present disclosure relates to water pipe adapters and, more particularly, to a water pipe adapter with two ends each having a male thread segment.

### 2. Description of Related Art

In addition to welding, it is not uncommon to connect a water pipe and another water pipe by threads. The latter technique requires one of the two connected water pipes to have a male thread and the other one to have a female thread. In this regard, a well-known drawback of the prior art related to the threads of water pipes is: two water pipes need to be connected but cannot, because both have a connection end with a female thread. An adapter is the cure for the aforesaid drawback of the prior art.

Referring to FIG. 5, a water pipe adapter assembly 4 comprises two connection pipes 41A, 41B each having a male thread connection end 411 and a plugging/unplugging fixing element 42. Male thread connection ends 411 of the connection pipes 41A, 41B mesh with female thread connection ends 51, 52 of water pipes 5A, 5B, respectively. Then, the connection pipes 41A, 41B are engaged and connected by the plugging/unplugging fixing element 42 to finalize the process of connecting the water pipes 5A, 5B. However, the water pipe adapter assembly 4 has disadvantages as follows: a plethora of elements, structural complexity, and high manufacturing costs. Last but not least, with the elements being separate, the process of connecting water pipes must be divided into several steps and thus is disadvantageously inconvenient to carry out.

### BRIEF SUMMARY OF THE INVENTION

It is an objective of the present disclosure to provide an adapter with two male threads. The two ends of a body of the adapter each have a male thread segment. The adapter connects two water pipes each having a female thread connection end. Therefore, the adapter is structurally simple and incurs low manufacturing costs. Furthermore, the adapter has a hanger which allows the body of the adapter to be hung from a corresponding one of the water pipes; hence, the corresponding water pipe can be conveniently stored.

In order to achieve the above and other objectives, the present disclosure provides an adapter with two male threads, the adapter comprising:

an integrally-connected body with two ends penetrated by a through hole, the two ends each having an external thread segment, the body having two spaced-apart flanges between the two external thread segments, wherein a groove is formed between the two flanges; and

a hanger with an end having a first connecting portion connectedly disposed in the groove and another end having a second connecting portion connected to an external object.

In an embodiment, the two flanges run around the body and thus are annular, and the groove is annular. Furthermore, circumferential surfaces of the two flanges each have a plurality of facets.

In an embodiment, the first connecting portion and the second connecting portion of the hanger are ring-shaped and have enlargeable inner diameters. Furthermore, the first connecting portion and the second connecting portion of the hanger are made of a soft, deformable material.

### BRIEF DESCRIPTION OF THE SEVERAL VIEWS OF THE DRAWINGS

FIG. 1 is a perspective exploded view of an adapter with two male threads according to the present disclosure;

FIG. 2 is a schematic view of how to use the adapter according to the present disclosure;

FIG. 3 is a schematic view of how to use the adapter, when connected between two water pipes each having a female thread connection end, according to the present disclosure;

FIG. 4 is a cross-sectional view of the adapter connected between two water pipes each having a female thread connection end according to the present disclosure; and

FIG. 5 (PRIOR art) is a schematic view of how to connect two conventional water pipes each having a female thread connection end.

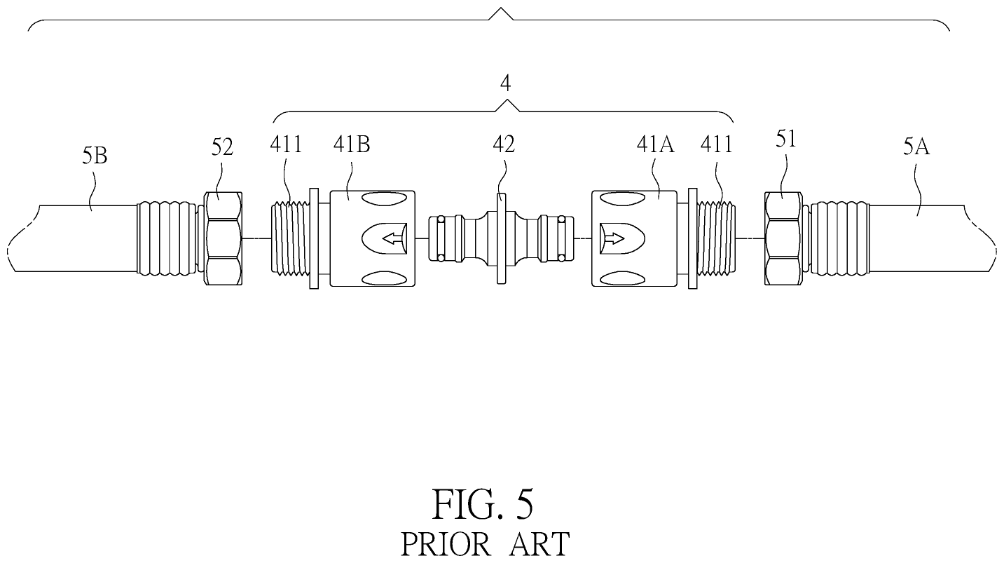

### DETAILED DESCRIPTION OF THE INVENTION

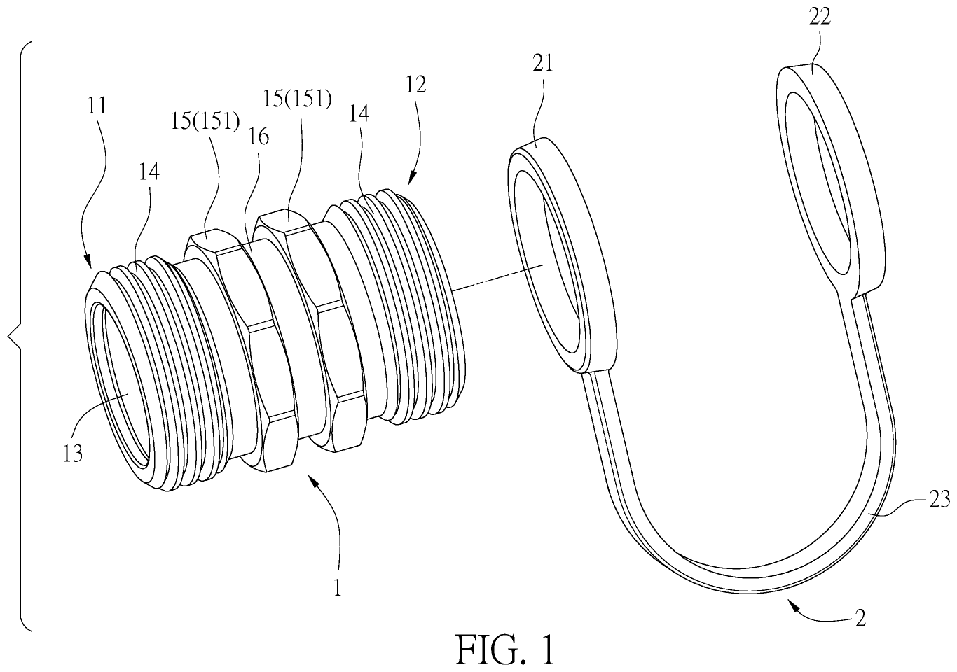

Referring to FIG. 1, the present disclosure provides an adapter with two male threads. The adapter comprises a body 1 and a hanger 2. The body 1 is an integrally-connected tubular structure with a first end 11 and a second end 12. The body 1 has therein a through hole 13 which penetrates the body 1 from the first end 11 to the second end 12. The first end 11 and the second end 12 each have an external thread segment 14, commonly known as male thread. The body 1 has two flanges 15 between the two external thread segments 14. In this embodiment, the two flanges 15 run around the body 1 and thus are annular. The two flanges 15 are spaced apart such that an annular groove 16 is formed therebetween.

The circumferential surface of each flange 15 has a plurality of facets 151 designed to be gripped by a tool, such as pliers, for rotating the body 1. The circumferential surfaces of the two flanges 15 have six or eight said facets 151 in total.

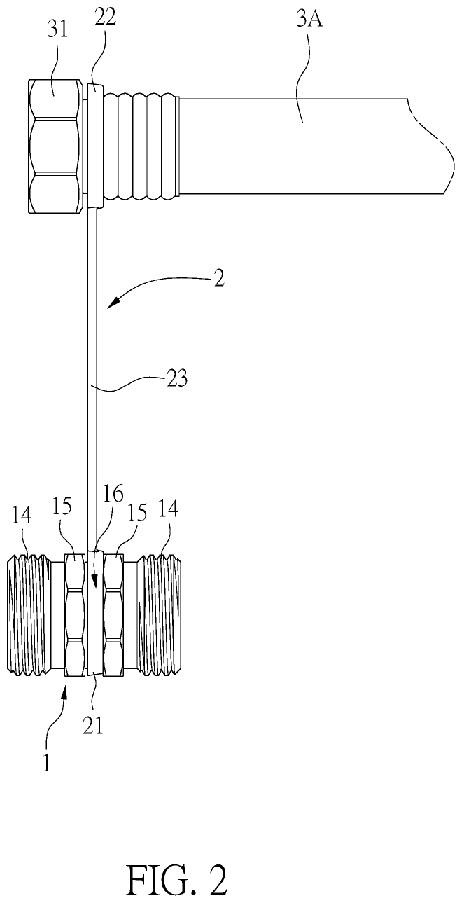

The hanger 2 has a cord 23 of an appropriate length. Two ends of the cord 23 have a first connecting portion 21 and a second connecting portion 22, respectively. As shown in FIG. 2, the first connecting portion 21 is connectedly disposed in the groove 16, whereas the second connecting portion 22 is connected to an external water pipe 3A, thereby allowing the body 1 to be hung from the water pipe 3A. In this embodiment, the first connecting portion 21 and the second connecting portion 22 are made of a soft, deformable material, such as silica gel or rubber, and made ring-shaped to not only expand and enlarge their inner diameters when stretched under an external force but also restore their original shapes upon removal of the external force. Therefore, a user pulls aside the first connecting portion 21 such that the first connecting portion 21 passes the corresponding one of the flanges 15 and enters the groove 16. At this point in time, the user releases the first connecting portion 21 such that the first connecting portion 21 is confined to the groove 16 and fastened to the body 1. Similarly, the second connecting portion 22 is fastened to the water pipe 3A.

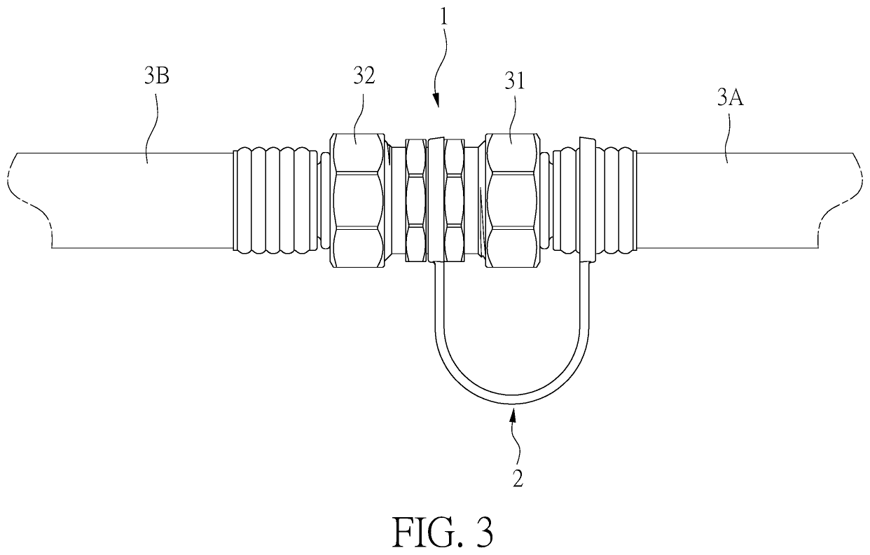

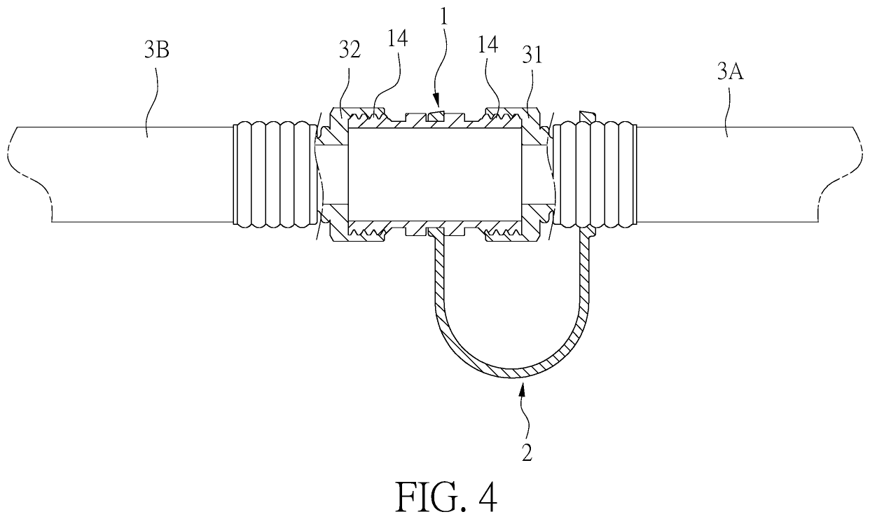

Given the aforesaid structures, the user may fasten the second connecting portion 22 of the hanger 2 to the water pipe 3A with a female thread connection end 31, as shown in FIG. 2, so as for the water pipe 3A to be conveniently stored for later use. Afterward, to connect the water pipe 3A to a water pipe 3B with a female thread connection end 32, the user only needs to fasten the external thread segments 14 of the body 1 to the female thread connection ends 31, 32 of the two water pipes 3A, 3B, respectively, as shown in FIGS. 3, 4, thereby connecting the two water pipe 3A, 3B quickly and firmly.

Compared with the conventional water pipe adapter assembly, an adapter with two male threads of the present disclosure has a simplified, integrally-connected structure to therefore not only achieve its inherent efficiency of connection without reducing its required structural strength, but also cut its manufacturing costs and thus increase its price competitiveness in markets.

What is claimed is:

1. An adapter with two male threads, the adapter comprising:
an integrally-connected body with two ends penetrated by a through hole, the two ends each having an external thread segment, the body having two spaced-apart flanges between the two external thread segments, wherein a groove is formed between the two flanges; and
a hanger with an end having a first connecting portion connectedly disposed in the groove and another end having a second connecting portion connected to an external object.

2. The adapter with two male threads according to claim 1, wherein the two flanges run around the body and thus are annular, and the groove is annular.

3. The adapter with two male threads according to claim 2, wherein circumferential surfaces of the two flanges each have a plurality of facets.

4. The adapter with two male threads according to claim 1, wherein the first connecting portion and the second connecting portion of the hanger are ring-shaped and have enlargeable inner diameters.

5. The adapter with two male threads according to claim 4, wherein the first connecting portion and the second connecting portion of the hanger are made of a soft, deformable material.
